(19) United States
(12) Patent Application Publication
(10) Pub. No.: US 2014/0252685 A1
(43) Pub. Date: Sep. 11, 2014

(54) Powder Bed Fusion Systems, Apparatus, and Processes for Multi-Material Part Production

(71) Applicant: University of Louisville Research Foundation, Inc., Louisville, KY (US)

(72) Inventors: Brent E. Stucker, Louisville, KY (US); Thomas L. Starr, Louisville, KY (US); Timothy J. Gornet, Louisville, KY (US)

(73) Assignee: University of Louisville Research Foundation, Inc., Louisville, KY (US)

(21) Appl. No.: 14/198,674

(22) Filed: Mar. 6, 2014

Related U.S. Application Data
(60) Provisional application No. 61/773,509, filed on Mar. 6, 2013.

(51) Int. Cl. B29C 67/00

(52) U.S. Cl. CPC B29C 67/0077; B29C 67/0085
USPC 264/401; 425/375; 425/174.4; 425/78; 264/122; 264/40.1

(57) ABSTRACT

Powder bed fusion systems, apparatus, and processes for the production of multi-material parts are provided, in which the material composition varies throughout the part, including different regions within a particular layer. Present embodiments include the capability to selectively deliver fusion-inducing energy over the part bed as each layer of the part is made, rather than uniformly over the part bed.

### CROSS REFERENCE TO RELATED APPLICATIONS

This application claims priority to U.S. Provisional Application No, 61/773,509, tiled on Mar. 6, 2013, the teachings and entire disclosure of which are lay incorporated herein by reference.

### FIELD OF INVENTION

Present embodiments relate to powder bed fusion systems, apparatus, and processes for the production of multi-material parts, in which the material composition may vary throughout the part, e.g., within certain regions of the part, between two layers of the part, or within a particular layer of the part.

### BACKGROUND

Powder bed fusion processes are additive manufacturing processes for making parts formed from metal, ceramic, polymer, and composite powder materials. These processes induce fusion of particles by exposing them to one or more thermal sources, which are generally laser, electron beam, or infrared sources. Some approaches fuse the particles in the solid state (i.e., below the melting temperature), some in the liquid state after melting, and some through partial melting. Fusion in the solid state is generally referred to as solid-state sintering. The mechanism for sintering is primarily diffusion between powder particles: because surface energy is proportional to total particle surface area, when particles reach sufficiently high temperatures, total surface area decreases in order to decrease surface energy which results in particle fusion.

Common approaches for fusion in the liquid phase include full melting, liquid-phase sintering, and indirect fusion. Generally, metal, ceramic, and polymer materials capable of being melted and resolidified can be used for these approaches. With full melting, particles are fused by fully melting them with a high-power laser or electron beam. Liquid-phase sintering uses a mixture of two metal powders or a metal alloy, in which the thermal source melts a lower-melting-temperature constituent, but a higher-melting-temperature constituent remains solid. The lower “melting” temperature constituent is sometimes referred to as the binder particle and the higher melting temperature constituent as the structural particle. An example of indirect fusion is a powder material comprising structural particles (e.g., a metal) coated with a binder (e.g., a polymer). Exposure to the thermal source melts the binder, thus inducing fusion, while the structural particle remains solid.

Additive manufacturing systems build the solid part one layer at a time. Typical layer thicknesses range from about 0.02-0.15 mm. Laser-based thermal sources for inducing fusion between particles include carbon dioxide (CO₂) lasers, fiber lasers, diode lasers, and neodymium-yttrium aluminum garnet (Nd-YAG) lasers. Generally, laser-based thermal sources are suitable for both metal and polymer fusion, while a higher-energy electron beam is used only for metal powder particles and typically results in full melting before resolidification.

Besides selecting the powder material and thermal source, these approaches require that powder fusion occur only within prescribed regions of the part bed, and to the appropriate depth. Because parts are formed layer-by-layer, powder must be properly handled as each layer of the part is deposited and formed. Accordingly, various aspects of process control must be managed during powder bed fusion. These include laser-related parameters (e.g., laser power, spot size, pulse duration and frequency); scan-related parameters (e.g., scan pattern, speed and spacing); powder-related parameters (e.g., particle shape, size and distribution, powder bed density, layer thickness, material properties, and uniform powder deposition); and temperature related parameters (powder bed temperature, powder material supply temperature, temperature uniformity, and temperature monitoring).

U.S. Pat. No. 7,879,282, titled “Method and apparatus for combining particulate material,” describes the printing of infrared absorbing inks onto the powder in selected regions to modify the sintering characteristics of the powder materials. During exposure to infrared energy, particles in regions printed with the ink absorb energy at a faster rate, thereby sintering those particles, but material in other regions remains un-sintered. With such approaches, the energy is uniformly directed across the part bed rather than selectively directed. The same is true for other approaches that use sintering inhibitors printed in regions where fusion is not desired, and ones that involve placing a masking plate with openings to cover regions where fusion is not desired. While such approaches are commonly used for single component parts, they are less efficient and perform inconsistently with multi-material parts.

### SUMMARY OF INVENTION

The present embodiments are better for producing multi-material parts than the approaches described in the preceding paragraphs. Multi-material parts include those in which the material composition varies throughout the part, including different regions within a particular layer, in order to impart needed or desired properties. These also include parts containing modifiers, such as conductors, insulators, electronic traces, heating traces for zoned temperature control, and dielectric promoters, which are printed onto the part using a print head and positioned at specific locations within the part. Multi-material parts also include those incorporating additives that result in specific regions of the part having improved properties; examples of this would include a second metal, powder suspended in an organic carrier liquid printed with an ink jet print head over a primary material. Present embodiments are also suitable when other fillers are incorporated with the powder materials, such as a powder mixture comprising metal, ceramic, or polymer material with glass beads or carbon fibers in bulk, for increasing structural integrity, reducing porosity, or otherwise enhancing the properties of the built part.

Present embodiments described herein combine powder bed fusion processes—including one or more thermal sources that direct location-specific delivery of energy to particular regions within any given layer—with the printing of location-specific modifiers that impart desirable mechanical, electrical, and/or thermal capabilities for the production of multi-material parts. Because as each layer is formed thermal energy is selectively delivered to only certain regions of the part bed, it is unnecessary to further alter the part bed by printing infrared absorbing inks or inhibitors, or by masking of powder material. Moreover, the addition of location-specific modifiers to particular layers or regions within layers adds flexibility—providing a broader range of parts and features—compared to such prior approaches as modifying the infrared absorption characteristics of the powder followed by application of a general (i.e., substantially uniform over the layer) thermal source to fuse the particles. One example of such flexibility is the ability to expose the powder layer to a general heat source, such as an infrared heater, followed by location-specific exposure using a laser-based source.

### BRIEF DESCRIPTION OF THE DRAWINGS

The drawings and figures provided are illustrative of multiple alternative structures, aspects, and features of the present embodiments, and they are not to be understood as limiting the scope of present embodiments. It will be further understood that the drawing figures are not to scale, and that the embodiments are not limited to the precise arrangements and instrumentalities shown.

FIG. 1 is an elevated view of a powder bed fusion machine, according to multiple embodiments and alternatives.

FIG. 2 is a block diagram of a powder bed fusion process control system for a laser-based thermal source, according to multiple embodiments and alternatives.

### MULTIPLE EMBODIMENTS AND ALTERNATIVES

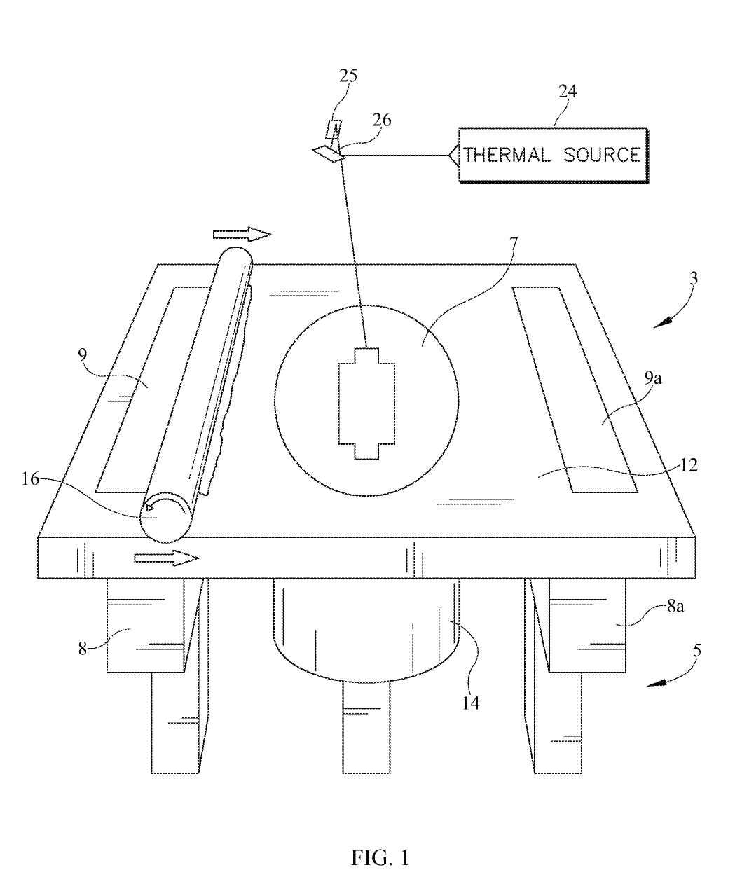

FIG. 1 illustrates a powder bed fusion machine 3 with material supply apparatus 5. Apparatus 5 generally consists of a material supply cartridge 8 (sometimes referred to as a “feed cartridge”), which has a bottom surface 9. A material supply piston (not shown) positioned below surface 9 moves the cartridge 8 vertically relative to machine bed surface 12. Generally, the substantially planar surfaces of bottom surface 9 and machine bed surface 12 are parallel. Preferably, an opening is formed in machine bed surface 12, the dimensions of which are substantially equal to bottom surface 9, and material supply cartridge 8 is aligned with that opening. Optionally, as shown in FIG. 1, multiple material supply cartridges 8, 8a are provided, each having a bottom surface 9, 9a and piston as described above. This allows more efficient powder feeding by eliminating the need for the roller to return to one side before feeding the next layer of powder. Multiple powder feeders also enable different powder material types to be selected and used in the case of multi-material parts.

Before a part is built, a required volume of powder material is determined, which will be supplied from material supply cartridge 8. Numerous materials are suitable for these processes. Example metal materials include titanium, aluminum, copper, and stainless steel alloys. Example polymer materials include nylon polyamide and other polyamides, polycarbonate, polystyrene, and polyether ether ketone.

Material supply cartridge 8 is then lowered until bottom surface 9 occupies a specified position below machine bed surface 12, consistent with the determined volume. In some embodiments, the material supply piston is moved through operation of a controller (not shown). At this point, bottom surface 9 and the four walls of material supply cartridge 8 form a powder reservoir, which is open at the top. This is then filled with material, which is leveled substantially evenly with machine bed surface 12. Thus, depositing material for a given layer of the part, in an area defined by part bed surface 7, is ready to commence, and this is performed in certain embodiments with use of applicator 16, as further explained below.

As also shown in FIG. 1, powder bed fusion machine 3 includes a part bed surface where the part is built. Generally, the part bed surface 7 occupies a smaller sub-area of the overall machine bed surface 12. In some embodiments, a part bed piston (not shown) within a part cylinder 14 moves part bed surface 7 vertically relative to machine bed surface 12. Preferably, an opening is formed in machine bed surface 12, the dimensions of which are substantially equal to the dimensions of part bed surface 7, and surface 7 is aligned with that opening. Initially, surface 7 should be substantially level with machine bed surface 12. Because parts are formed beginning at the bottom layer and moving up layer-by-layer, as each layer is formed the part bed piston lowers surface 7 a distance substantially equal to the layer thickness. This maintains the top-most layer of the part (as it is being built) at a substantially constant height relative to machine bed surface 12.

In some embodiments, applicator 16 is used for depositing material from material supply cartridge 8 in an area defined by part bed surface 7. FIG. 1 shows applicator 16 as a counter-rotating powder leveling roller, in which the roller rotates in the opposite direction (indicated by arrows) of its liners travel. As this applicator 16 traverses horizontally across machine bed surface 12, the powder is pushed by applicator 16 away from material supply cartridge 8, toward part bed surface 7, where the material is deposited. Then after each is layer is deposited, cartridge 8 is raised up incrementally, approximately equal to the amount of material used in preparation for depositing the next layer. As FIG. 1 illustrates, the counter-rotation of applicator 16 creates a flow of powder in front of it that lifts and moves the powder. The previously processed layers are relatively undisturbed given the fairly small shear forces created by applicator 16's counter-rotating roller.

Optionally, the roller can be attached to a platform (not shown) that is moved through operation of the controller. This allows other structures to be added to the platform, e.g., print heads and infrared heater (not shown). As discussed further below, the print heads, e.g., a commercially available industrial inkjet print head(s) as known to persons having ordinary skill in the art, including but not limited to piezoelectric ink jet and drop-on-demand, are used for printing modifiers and additives at various layer positions of the part as it is being built. An infrared heater is used in some embodiments for preheating the material and part bed surface, for the sintering of particles, for evaporating residual print media associated with the depositing of materials, and the like. Alternatively, in some embodiments the infrared heater is configured to expose the powder layer to a general heat source for the initial stage of powder fusion, followed by location-specific exposure using a laser-based source to provide enhanced durability in selected areas of the part.

In some embodiments, the aforementioned controller is a processor-based device (with one example being a personal computer) operationally connected to various system components as described herein, and which includes a memory and program instructions for receiving inputs and executing software commands to control various elements. The elements include but are not limited to the operation, including but not limited to positioning, of part bed surface 7, material supply cartridge 8, and mirrors 25, 26; and of applicator 16 and platform, print heads, infrared heater, infrared camera, and thermal source 24. Although the controller is referred to as a single device, optionally it may be provided as several individual controllers or microprocessors, some or all of which may be centrally controlled by an internal controller.

Summarizing, for each layer of the part, applicator 16 deposits material from material supply cartridge 8 over part bed surface 7. Material supply cartridge 8 is then raised incrementally according to the volume needed to spread (synonymous with deposit) a layer of defined thickness. Thermal energy from thermal source 24 is directed to part bed surface 7 sufficient to induce fusion of particles of matter within the desired cross-sectional geometry of the part object). As energy dissipates with cooling, atoms from neighboring particles fuse together. In some embodiments, the scan pattern results in fusion of particles both within the same layer and in the previously formed and resolidified adjoining layer(s) such that fusion is induced between at least two adjacent layers of the part, i.e., between one or more materials in a deposited unfused layer and a previously-fused adjacent layer. With each layer, part bed surface 7 is adjusted by one layer thickness (e.g., by lowering), before the next adjacent layer of powder for the part is laid and leveled using applicator 16. This process is then repeated over multiple cycles as each part layer is added, until the full 3-D (i.e., 3-dimensional) part is formed. As the part is built, and because the energy is selectively directed, powder outside the scan area remains loose and serves as support for subsequent layers. Frequently, other structural supports are used for maintaining the shape of the part as it is built.

Besides applicator 16, additional options exist for supplying and depositing materials in an area defined by part bed surface 7. Alternative powder supply systems include, but are not limited to, positioning one or a plurality of hoppers (not shown) above the level of machine bed surface 12, filling each hopper with material, and providing means for each hopper to deposit material to appropriate positions on the part bed surface 7. Alternative powder depositing systems include, but are not limited to, a rigid or flexible blade (not shown). The blade is used to scrape and thereby spread material across part bed surface 7. These alternative systems can be effectuated through operation of the controller. In some embodiments, applicator 16 in the form of a blade is formed integrally with material supply cartridge 8. Alternatively, the blade and cartridge 8 are separate pieces within a material depositing system.

Once the part is completed, a cool-down period is typically required to allow the layers to uniformly reach a sufficiently low temperature for handling and exposure to ambient conditions. Preferably, throughout the process the height of applicator 16 remains constant relative to machine bed surface 12, thus keeping layer thickness substantially uniform.

For any given layer, the amount of material transferred to part bed surface 7 may exceed what will be needed to form the layer. To avoid unnecessary waste of material, in some embodiments the system 3 includes a second blade (not shown) that is configured to remove any material that either does not reach the part bed surface 12, or that is not scanned. Such material can then be recycled. The removal of excess material can occur after each layer is scanned and/or upon completion of the part.

Following layer deposition and before fusion is induced, the material is often preheated to a temperature sufficient to reduce undesirable shrinkage and/or to minimize the laser energy needed to melt the next layer. For laser-based processes, this can be performed using the infrared heater attached to the applicator platform or through other means of directing thermal energy within an enclosed space around part bed surface 7. For electron beam melting, this can be done by defocusing the electron beam and rapidly scanning it over the powder material or part bed surface. After preheating, a focused thermal energy source sufficient for fusion is directed onto part bed surface 7. Each part has a 3-D solid model created in CAD software. This 3-D model is sliced using conventional algorithms as are known in the art to generate a series of 2-D (i.e., 2-dimensional) layers representing individual transverse cross sections of the part, which collectively depict the 3-dimensional part. This 2-D slice information for the particular layers is sent to the controller and stored in memory, and such information controls the process of fusing particles into a dense layer according to the modeling and inputs obtained during the build.

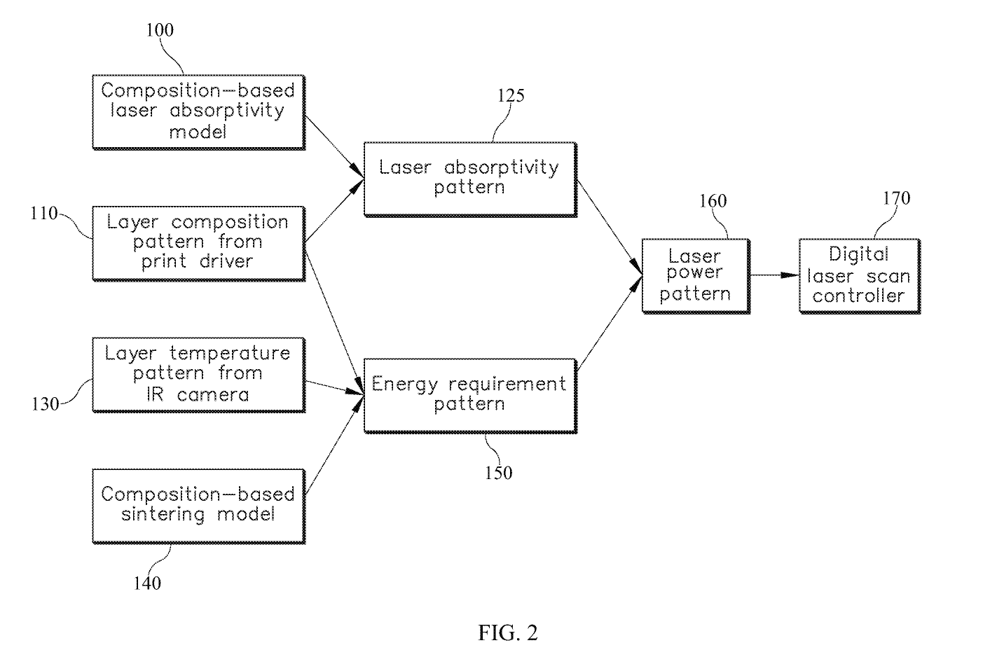

For laser-based thermal systems, one or more mirrors (preferably first mirror 25 in FIG. 1 for the x-axis and second mirror 26 for the y-axis) direct the energy toward the part bed, according to the geometry of the part layer and the energy requirements within the layer. In some embodiments, mirrors 25, 26 are used to optically focus and deflect photons from a laser-based thermal source. The minors can be formed from a variety of materials known in the art, including aluminum as a non-limiting example, and in some embodiments they are moved and positioned by motor-driven galvanometers which are tracked and controlled by the controller. Accordingly, the linear positioning, height, and angling of the mirrors adjusts the laser beam to direct the fusion-inducing energy across the layer cross-section. Alternatively, a digital light processing (DLP) chip interfaces with the thermal source to direct the application of energy from the thermal source. Thus, rather than providing the same level of energy uniformly across the entire powder surface, the exposure to energy is selectively directed in a location-specific manner, such that the energy directed and absorbed varies by region of the part bed according to the scan pattern discussed in connection with FIG. 2.

Scanning often occurs in contour mode and fill mode. In contour mode, the outline of the part cross-section for a particular layer is scanned. This is typically done for accuracy and surface finish around the perimeter. The rest of the cross-section is then scanned using a rastering technique whereby one axis is incrementally moved a laser scan width, and the other axis is continuously swept back and forth across the layer part. In some cases the fill section is subdivided into squares, with each square being scanned separately and randomly to avoid preferential residual stress directions. Alternative approaches to scanning include scanning in thin strips lengthwise across the layer.

FIG. 2 shows a block diagram including inputs for generating the laser scan patterns and settings. At the outset, several factors influence the scan pattern initially, e.g., the nature of the part; composition-based parameters of the constituents such as thermal absorptivity and conductivity, ratio of energy absorbed/reflected, heat capacity and heat of fusion; and depth of scan. Inputs for such parameters are input to the controller at block 100.

Modifiers and additives printed to the part via the print head may also influence the scan pattern by altering the energy requirements needed for successful fusion. In general, the laser absorptivity pattern 125 is primarily determined by model 100 and the layer is either treated as a homogenous layer of the part or an inhomogeneous layer. In some embodiments, at block 110, the controller drives the print heads in depositing modifiers and dispensing additives through the ink jet print heads to the part layers. In some embodiments, the print head traverses the part bed surface independently of applicator 16, for example either in parallel or perpendicular to the motion of the applicator.

If modifiers or additives are incorporated within a particular layer, block 110 also includes inputs to alter the scan pattern if needed, for example due to the layer being inhomogeneous and leading to differential shrinkage or stresses associated with a particular layer. If a layer contains modifiers or additives, the printing mechanism is activated as applicator 16 traverses part bed surface 7 and input adjustments are made to the laser absorptivity pattern at block 125. If a layer is inhomogeneous because the material composition varies throughout the layer, or because it contains modifiers or additives, input adjustments are made to the laser absorptivity pattern at block 125.

It is generally expected that temperature will vary from region to region of the powder layer. Factors that influence temperature variance include previous layer scanning, variable heater irradiance, variations in absorptivity of the composition, powder bed temperature, powder material supply temperature, loose (un-fused) powder temperature, and the use of modifiers and additives. Accordingly, block 130 indicates the use of image and temperature measurement inputs based upon layer temperature patterns captured by the infrared camera. This data is overlaid upon the composition-based sintering model for each 2-D layer that the algorithm generates as a sintering model at block 140. In turn, the real time temperature inputs at block 130 and the sintering model are factors determining an energy requirement pattern at block 150 for any one or more subsequent layers.

Based upon laser absorptivity (125) and energy requirement (150) patterns, the required laser power pattern is determined at block 160, which in turn influences scan pattern, speed and spacing. The final step in FIG. 2 at block 170 represents controller directing the scan of laser energy for fusing the particles. It will be appreciated that FIG. 2 depicts an exemplary control loop associated with the formulation and direction of a scan pattern. However, other process control strategies are contemplated, and present embodiments are not limited to the steps or sequences shown in FIG. 2.

As a part is being formed, the fusion occurring within the cross-sectional geometry of the part typically causes that area to become much hotter than the surrounding loose powder. It is expected that the just-formed part cross-section will be very hot, particularly if melting is the dominant fusion mechanism (as is typically the case). As a result, the loose powder bed immediately surrounding the fused region heats up considerably, due to conduction from the part being formed. The infrared camera obtains images of thermal activity in the surrounding loose powder, and the controller adjusts the scan pattern for a given layer accordingly. For example, thermal activity in the loose powder may prompt a reduction in laser power or pulse duration. With respect to the latter, it will be appreciated that embodiments contemplated herein include delivery of thermal energy from continuous wave sources and from a pulsed energy sources.

Similar principles apply when fusion is induced by electron beam melting. However, whereas with laser-based sources heat transfer occurs as photons are absorbed by the powder particles, with electron beam melting a stream of electrons heats the material through the transfer of kinetic energy from incoming electrons to powder particles. This leads to several changes in how processing occurs. Instead of an infrared camera to monitor temperature changes, electron beam melting may use empirical data to adjust for increasing negative charge in the powder particles. Otherwise, these effects would repel the incoming negatively charged electrons and create a more diffuse beam. Instead of minors that deflect and focus the beam, the electron stream is focused magnetically by deflection coils. Accordingly, the part building process occurs inside an enclosed chamber to maintain a vacuum atmosphere. (For laser based processes, an inert gas atmosphere is typically used to minimize oxidation and degradation of the material.)

The present embodiments also contemplate the use of various modifiers within the layers themselves, which are selectively printed onto specific regions of the powder in order to impart various desirable mechanical, chemical, magnetical, electrical or other properties to the part. Such modifiers include, but are not limited to, electrical conductors and insulators, thermal conductors and insulators, sensors, locally-contained heater traces for multi-zone temperature control, batteries, and dielectric promoters. In some embodiments, at least one or a plurality of print heads (not shown) are attached to the platform of applicator 16 for printing such modifiers. As desired, such modifiers are printed before sintering of a particular layer has occurred, or, alternatively, printed over a layer that has been sintered, before material for the next layer is deposited to part bed surface 7.

As an example of using a modifier, one may consider a polyamide part fabricated from commercially available polyamide powder, in which an array of electrically conductive traces are incorporated as an antenna to selectively absorb radiofrequency (RF) radiation within a specific and predetermined frequency range. The 3-D CAD software designates as a sub-part the layer(s) that have the traces for modified properties (high electrical conductivity), if these regions of the layer require different levels of energy for inducing fusion, compared to other regions having only the primary material, the scan pattern will be adjusted accordingly according to FIG. 2 teachings.

In the example, polyamide powder is supplied and deposited over part bed surface 7. An ink consisting of fine silver powder (1-5 micrometer) in an organic carrier liquid is loaded into the dispensing system of the print head. It will be appreciated that a wide range of print heads known to practitioners are suitable for the embodiments herein. It is desirable for the print heads to be capable of dispensing a wide range of inks as suitable for a given part. The organic carrier liquid or other carrier medium (i.e., a non-solid medium into which powder materials are dispersed so they can be deposited with use of a print head) preferably provides good wetting of both the fine powder and the primary material. Suitable organic liquid carriers have a boiling temperature low enough to readily evaporate after it is dispensed over the layer of powder material, but sufficiently high to avoid excessive evaporation in the print head that could result in clogging the nozzles. A short delay time may be used before scanning to allow the carrier liquid to fully evaporate, and this process will sometimes be aided by use of the infrared heater.

The start-up procedure for applying the thermal source (in this case, laser-based sintering) includes leveling surface 7 with machine bed surface 12 and spreading the first several layers of powder. The atmosphere is purged with nitrogen and the system is brought to its normal operating temperature.

The controller then begins creating the composite part. For the first layer, a powder layer is spread and selectively fused by the scanning laser to form one homogenous layer of the part. Additional layers of powder are spread and fused until the control system detects that the next 2-D layer contains a region of conductive trace. For the trace-containing layer, prior to spreading the polyamide powder the ink jet printing mechanism is activated. As the print head passes over the previously sintered area it deposits silver-ink selectively onto the areas that require conductive trace. The amount of ink deposited by the print head is controlled such that when the liquid carrier evaporates, the resulting silver traces will have the desired electrical or RF properties while keeping the total height of the silver trace less than the layer-thickness of polyamide powder so that it does not interfere with spreading of the next layer.

After completing ink deposition in selected areas of the part, the powder spreading mechanism spreads another layer of polyamide powder over the entire bed. (A small delay time may be inserted in the process to allow the ink carrier liquid to fully evaporate. A small delay time can also be inserted in the process to enable laser scanning of the just-deposited trace to melt the silver particles together to increase the trace's electrical conductivity.) The laser scanning mechanism selectively directs sufficient energy to form the layer. For regions of the layer consisting of silver powder, the amount, intensity and duration, of laser energy the controller directs may be adjusted, generally based on empirical data, to provide effective bonding of the silver particles to each other and to enable fusion of the powder surrounding the silver particles.

Another example involves additives incorporated into the layers to impart improved properties in certain regions of the part. Examples of such additives include fine boron powder (particle diameter 0.1-5 micrometers) in an organic carrier liquid that is loaded into the dispensing system of the print head and printed over commercially pure titanium powder (particle diameter 10-50 micrometers) or some other primary material that is selected. The boron powder reacts with the titanium powder during melting to form micro and nano-precipitate structures to provide higher modulus of elasticity and improved wear resistance to certain regions of the part.

The CAD 3-D software designates the particular layer(s) having the additive as a sub-part. The slice information for the sub-part is sent to the controller, which determines based on the amount of additive whether the scan pattern must vary by region. If regions with additive require different levels of energy for inducing fusion, compared to other regions having only the primary material, the scan pattern is adjusted. This example would be carried out in substantially the same way for both laser-based and electron beam thermal sources, except the print head may be modified for electron beam melting to a liquid-free dispenser for the boron powder.

Many other examples could be provided for how the present embodiments overcome the challenges related to prior approaches. For example, an ink consisting of silicon powder in an organic carrier liquid is loaded into the dispensing system of the print head and printed over a region of a fused layer, to provide a resistive trace within the part. As desired, two (or more) print heads could be utilized, one for dispensing electrically conductive traces such as the silver powder example, and one for dispensing resistive traces within different regions throughout the part.

Various approaches, which are known to persons of ordinary skill in the art, may use bulk blending of fillers or other additives in the powder starting material. These approaches often produce segregation, agglomeration and/or settling within the bulk mixture. Or these may dramatically change properties such as absorptivity, viscosity of the melt pool, flow characteristics of the powder, and melting characteristics within layers or from layer-to-layer—which increases the difficulty of effectively processing in a bulk fashion. It is known that even slight changes in composition of the starting material can result in significant process variations for the laser sintering model. Consequently, the present embodiments address these problems by directing the correct amount of energy, to the right location of the part, at the right time and for the right duration of time as it is being built without affecting the composition and processing of the surrounding material.

Present embodiments include both powder metal processes and polymer processes, which are similar in several respects. The primary exceptions include differences in scan pattern strategies and other processing considerations, including the type of laser, with the correct wavelength needed to overcome higher reflectivities in metals. Another difference is that, with powder bed fusion, infrared heaters may be used to induce polymer sintering, but are likely to be ineffective for powder bed fusion of metals. Thus, the infrared heater is used primarily for polymer sintering, although with powder metal laser sintering the infrared heater may also have secondary uses, e.g., drying printed additives.

It will be understood that various parameters may need to be adjusted and optimized for a given part. Artisans will readily recognize such parameters and various operational conditions from the above descriptions that can be tailored for particular applications and uses. The foregoing descriptions and examples are presented for purposes of illustration, and are not intended to be exhaustive or otherwise limit the scope of the present embodiments. Obviously, applications, variations, and alternative embodiments are possible in light of these descriptions.

Also, it is to be understood that words and phrases used herein are for the purpose of description and should not be regarded as limiting. The use herein of “including,” “comprising,” “e.g.,” “containing,” or “having” and variations of those words is meant to encompass the items listed thereafter, and equivalents of those, as well as additional items.

What is claimed is:

1. A system configured for fabricating a three-dimensional object layer-by-layer using thermal energy sufficient to induce fusion of one or more materials, comprising:
a part bed surface where the object is formed;
material depositing means configured to deposit a plurality of materials one layer at a time in an area defined by the part bed surface;
a thermal source configured to selectively direct energy to the materials, wherein the amount of thermal energy absorbed varies by region of a layer; and
a controller operationally connected to the material depositing means and the thermal source.

2. The system of claim 1, wherein material depositing means are configured to deposit at least a first material and a second material in said area, such that different location-specific regions of a layer are defined by the presence of the first material and second material, respectively, and wherein the system is further configured to vary the energy intensity directed from the thermal source to the respective regions.

3. The system of claim 1, further comprising a laser as the thermal source, and at least one mirror for selectively directing energy from the laser to the part bed surface.

4. The system of claim 3, wherein the at least one mirror is configured to be adjustably positioned relative to height or angle in relation to the part bed surface.

5. The system of claim 1, further comprising a plurality of material supply cartridges arranged to store a first material and a second material, said first and second materials chosen from one or more of metal powder, ceramic powder, and polymer powder.

6. The system of claim 5, further comprising a machine bed surface with a plurality of openings formed therein to accommodate the plurality of material supply cartridges, wherein the part bed surface occupies a sub-area of the machine bed surface.

7. The system of claim 6, further comprising an applicator configured to traverse horizontally across the part bed surface for depositing material in the area defined by the part bed surface, wherein the applicator is configured to deposit the material one layer of material at a time according to a series of 2-dimensional images stored in the controller memory, the images collectively depicting the 3-dimensional object.

8. The system of claim 7, wherein the applicator includes a platform accommodating either of a print head or an infrared heater.

9. The system of claim 8, wherein the print head is for printing one or more of a modifier, a powder mixture, or an ink comprising a material in a carrier liquid.

10. The system of claim 7, further comprising a motor operationally connected to the controller and configured to move one or more of material supply piston, part bed piston, thermal source, at least one mirror, applicator, or applicator platform.

11. The system of claim 1, wherein the thermal source selectively directs energy to the materials according to a scan pattern stored in the controller memory.

12. The system of claim 1, wherein the thermal source is a magnetically focused electron beam.

13. The system of claim 1, wherein the thermal source is infrared energy.

14. The system of claim 1, further comprising means for collecting excess unfused material for recycling.

15. A method for fabricating a three-dimensional object layer-by-layer using thermal energy sufficient to induce fusion of one or more materials, comprising:
depositing a first material from a material supply source in an area defined by a part bed surface, the first material being either metal powder, ceramic powder, or polymer powder;
depositing a second material in the area defined by the part bed surface, the second material being one or more of metal powder, ceramic powder, polymer powder, powder mixture, or a modifier, the deposited first and second materials forming an unfused layer;
selectively directing energy from a thermal source within the area defined by the part bed surface to expose the unfused layer to thermal energy sufficient to induce fusion of one or more of the materials; and
repeating the steps a plurality of times whereby fusion of one or more materials occurs in each deposited layer;
wherein different location-specific regions of a layer are defined by the presence of the first material and second material, respectively, and the energy directed from the thermal source varies according to the location-specific regions within a layer by varying the energy intensity from the thermal source.

16. The method of claim 15, further comprising inducing fusion of one or more materials in an unfused deposited layer with an adjacent previously-fused layer.

17. The method of claim 15, wherein the thermal source is a laser-based thermal source, and further comprising positioning at least one mirror relative to the part bed surface to selectively direct energy from the thermal source.

18. The method of claim 15, wherein the at least one mirror is adjustable based on height or angle in relation to the part bed.

19. The method of claim 15, wherein the thermal source directs either a continuous wave of energy or pulsed energy.

20. The method of claim 19, further comprising, when the thermal source directs pulsed energy, adjusting the energy directed from the laser-based thermal source, based upon one or more of pulse intensity, pulse duration, or pulse frequency.

21. The method of claim 15, wherein the thermal source is an electron beam, and further comprising detecting an increase in negative charge associated with the object and then adjusting the energy directed from the electron beam.

22. The method of claim 15, wherein the directing of energy is controlled by a controller and is selectively determined according to a scan pattern stored in the controller memory.

23. The method of claim 22, wherein the scan pattern is determined by one or more parameters chosen from material particle shape, material particle size, material particle distribution, layer thickness, powder bed temperature, and material supply temperature.

24. The method of claim 15, further comprising generating a series of 2-dimensional images, corresponding to layers of material to be deposited, wherein the 2-dimensional images are stored in the controller memory and collectively depict the 3-dimensional object.

25. The method of claim 24, further comprising detecting whether a particular layer is homogenous or inhomogeneous, and varying the scan pattern according to location-specific regions within a layer if the layer is inhomogeneous.

26. The method of claim 24, further comprising adjusting the positioning of the part bed surface relative to the thermal source.

27. The method of claim 15, further comprising monitoring temperature within the area defined by the part bed surface after a plurality of layers have been fused and determining an energy requirement pattern for a subsequent layer of the object based on temperature.

28. The method of claim 15, further comprising collecting excess unfused material for recycling.

29. An apparatus integrally positioned within a fabricated three-dimensional object formed layer-by-layer from a plurality of materials using selectively directed thermal energy, the apparatus comprising:
one or more of an electrical conductor, an antenna configured to absorb radiation within a predetermined wavelength range, a heater trace, or a temperature sensor.
